(19) United States
(12) Patent Application Publication
(10) Pub. No.: US 2005/0093891 A1
(43) Pub. Date: May 5, 2005

(54) Image orientation apparatus and method

(75) Inventor: J. Carl Cooper, Los Gatos, CA (US)

Correspondence Address: David R. Stevens;Stevens Law Group, P.O. Box 1667, San Jose, CA, 95109, US

(73) Assignee: Pixel Instruments Corporation, Los Gatos, CA (US)

(21) Appl. No.: 10/701,829

(22) Filed: Nov. 4, 2003

(51) Int. Cl. G06T 11/20

(52) U.S. Cl. 345/649

(57) ABSTRACT

A digital imaging system, such as a digital camera or video recorder, including an image sensor, an orientation sensor, and an image manipulator. The image manipulator receives image sensor orientation data (camera orientation data), and real image orientation; and adjusts the virtual image orientation.

### BACKGROUND

The invention relates to digital imaging systems, such still cameras, video cameras, CCD arrays, scanners incorporating image analysis for transforming the image in a way that facilitates its interpretation. Specifically, my invention relates to correcting undesirable image characteristics such as mis-alignment and mis-orientation, where alignment and orientation properties extracted from an image are those relating to its inclination or skew angle measured with respect to, for example, the physical orientation of a camera sensor array or the horizon. The alignment and orientation properties are used to shift (that is, rotate) the image from one position in space to another position for the purpose of turning the image (or a signal representation of the image) about an axis or center, to adjust the image's orientation, alignment, or skew.

Digital imaging systems are becoming ubiquitous. And, as resolution approaches that of conventional film cameras, and optics improves apace, there is a need for serious amateur and professional level “artistic controls.” At one level the “artistic controls” encompass those controls under the control of the photographer in a high end reflex camera and even in a view camera. At another level the “artistic controls” involve digital tools incorporated within the camera to facilitate a quality of image heretofore associated with high end reflex cameras.

One such element of “artistic control” involves horizontal alignment of the camera and the image. In high end reflex cameras of the prior art, horizontal alignment was frequently obtained by etched lines in the “ground glass” that divided the “ground glass” images into rectangles while providing horizontal and vertical reference lines.

The small size, light weight, and informality of the digital imaging experience to the user generally preclude etched horizontal and vertical lines on the “ground glass” (i.e., liquid crystal display) or, at least minimize the effects and value of such guides to the photographer.

Thus, a clear need exists for a built in tool to provide horizontal and vertical alignment. As will be seen, the invention fills this need in an elegant manner.

### SUMMARY OF THE INVENTION

The invention is directed to a novel method and apparatus configured to control the orientation of an image captured using photography techniques utilizing the invention, a user can direct a photographic device, such as a digital camera, at a subject and maintain a predetermined base line orientation of the image while recording the image information. A device embodying the invention includes an image sensor configured to sense an image and generate a signal defining the image. The device may further include scan electronics configured to scan the image into an electronic memory, and orientation electronics configured to receive a signal originating from the image sensor, and to adjust and correct the orientation of the image. An orientation sensor is further included to sense a change in the orientation of the image relative to a change in the orientation of the camera. The invention provides a built in tool to provide horizontal and vertical alignment for a digital imaging system. The digital imaging described herein, which may be, for example, a digital still camera or a video recorder, includes an image sensor, and an orientation sensor; and an image manipulator. The image sensor is a charge coupled device array, and the orientation sensor is a compatible gyroscope, such as an electronic gyroscopic sensor, a mechanical gyroscopic sensor, and or an optical gyroscopic sensor. The image manipulator, typically, an image rotator, receives image sensor orientation data (by “image sensor orientation data” is meant the orientation of the sensor with respect to the horizon), and image orientation data (by “image orientation data” is meant the orientation of the image with respect to the horizon); and uses these inputs to adjust the image orientation.

### THE FIGURES

Various exemplifications of the prior art and of the invention are illustrated in the Figures appended hereto.

FIG. 1 is an illustration of a camera of the prior art with the camera held horizontally, and a “landscape image” photographed in a “landscape” format.

FIG. 2 is an illustration of a camera of the prior art with the camera held vertically to capture a “portrait” image, with the image recorded as a “portrait” image on the full length of a horizontal image sensor.

FIG. 3 is an illustration of a camera utilizing the alignment systems of the present invention with the camera rotated and the image upright.

FIG. 4 is a partial cutaway of a digital camera incorporating the angular sensor of the invention, the angular sensor being mechanical with a pivot and mass.

FIG. 5 is a schematic view of the system of one embodiment of my invention, with correction of the image applied to the image in response to an output signal from the orientation sensor. The image sensor, such as a charge coupled device, is scanned by scan electronics to produce an orientation corrected image signal.

FIG. 6 is a schematic view of another embodiment of my invention where the image sensor and the scan electronics are coupled to the orientation sensor to cause the image to be read out of the sensor with the correct orientation.

FIG. 7 is a schematic view of another embodiment of my invention where the raw image is read out of the sensor and into a memory, as an image transfer memory or buffer.

FIG. 8 illustrates a diagram of a problem arising from image rotation when the aspect ratio of the image is other than 1:1.

FIG. 9 illustrates connecting an image sensor such as a camera to a display via electronic connection

FIG. 10 illustrates reorienting an image with respect to an image sensor.

FIG. 11 illustrates an embodiment of the invention where the display is configured to display the positional (i.e., angular or orientation) sensor to a user.

FIG. 12 illustrates another embodiment of the invention where the display is physically linked to the position sensor, (such as an angular sensor), with the sensor outputting a signal indicating the position of the display with respect to the viewer's perceived up orientation.

FIG. 13 shows another embodiment of the invention with a display device, where the angular sensor is coupled to the scan electronics for the display so that the scanning of the display can reorient and, optionally, resize the image as it is being displayed.

FIG. 14 shows another embodiment of the invention utilized with a display device wherein the angular sensor is coupled to the scan electronics to operate on an image signal which has been stored in memory.

FIG. 15 shows yet another embodiment of the invention wherein the image signal is stored in a memory, where image rotation and optional resizing electronics operate on the stored image in memory. The correctly oriented image may be restored in the memory in place of or in addition to the original stored memory.

### DETAILED DESCRIPTION OF THE INVENTION

The invention described herein is a system and apparatus for maintaining and /or correcting the orientation of images so that the recording, viewing, and displaying of the image occurs with the correct orientation, even if the image is acquired with incorrect orientation. The system and apparatus is particularly useful in automatically orienting images (for example, digital images) acquired by electronic imaging devices.

The invention is exemplified by a digital imaging system such as a still camera, cam- corder, or video camera, all of which are referred to herein as a “camera.” Alternatively, the imaging system may be a copier, fax machine, video phone, photo phone, or the like. The camera contains three systems, an image sensor, an orientation sensor; and an image manipulator. The image manipulator is a system within the camera that receives an indication of the image sensor orientation (which may be the camera's physical orientation, the orientation of a solid state image sensor within the camera whose position can be rotated or shifted, or a virtual orientation of the sensor obtained by selection of a “portrait” or “landscape” orientation), and using various internal and user supplied inputs, adjusts the image orientation.

The image sensor is typically a solid state optoelectronic device, as a charge coupled device array, a phototransistor array or a photodiode array, a CMOS device, a vacuum tube (as a vidicon tube) or even photographic film.

The orientation sensor is a gyroscope or virtual gyroscope, such as a microelectromechanical device, an electronic gyroscopic sensor, a mechanical gyroscopic sensor, or an optical gyroscopic sensor. Moreover, the orientation sensor can also be a virtual orientation sensor, such as would be used in a virtual “enlarging easel” or “virtual negative carrier” to align a “horizon” with the output picture borders or edges.

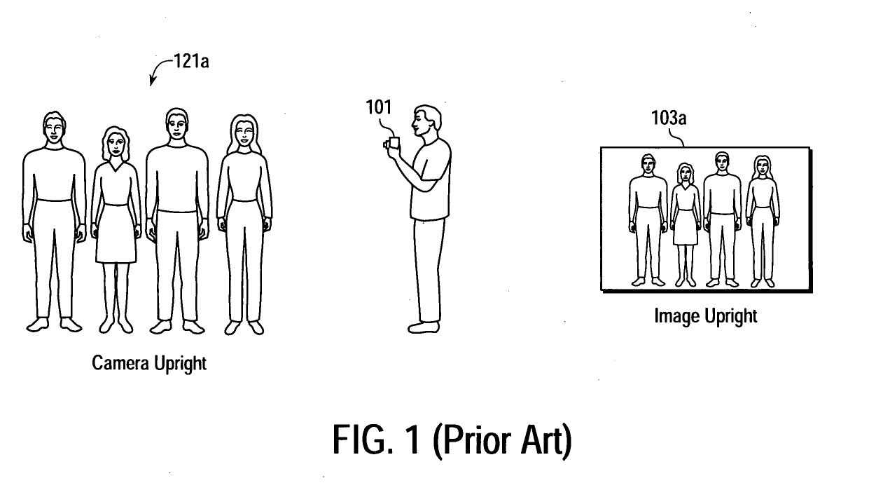

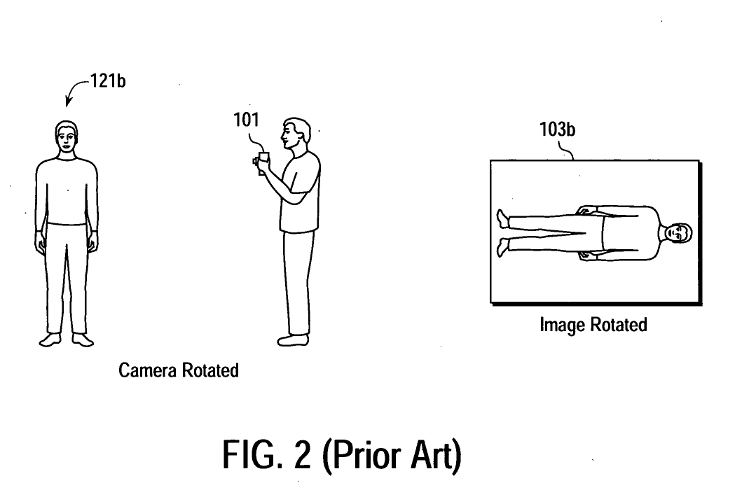

Within the context of the prior art, FIGS. 1 and 2, denominated “Prior Art” illustrate the use of digital cameras to acquire pictures of different orientations and aspect ratios. Specifically, in FIG. 1 the camera, 101, is oriented vertically to capture an image of a “landscape” scene, 121a, that is wider than high, and the image, 103a, is upright. However, in FIG. 2 the camera, 101, is rotated to facilitate a higher rather than wide (“portrait”) aspect ratio scene, 121b, and the image, 103b, is rotated.

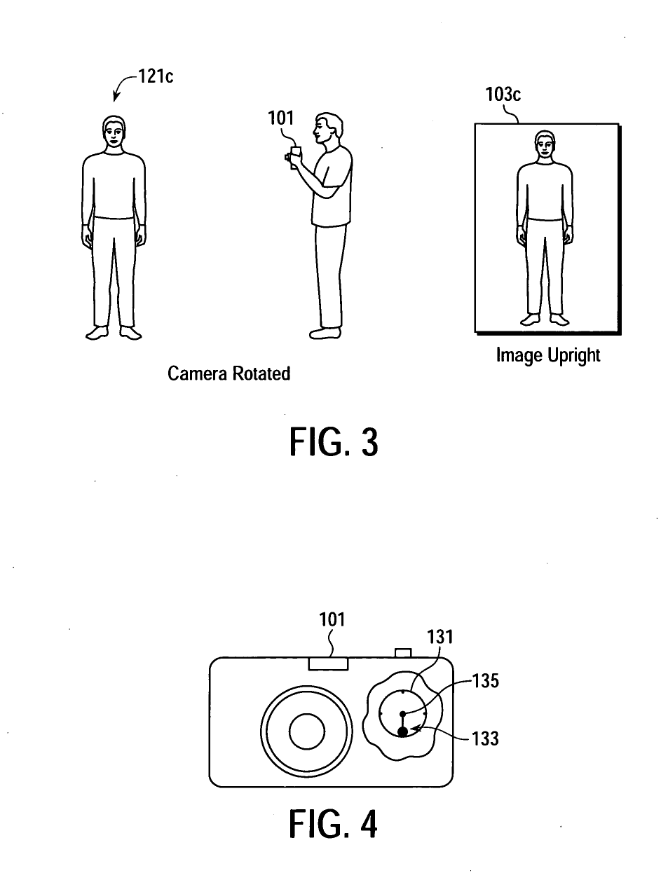

Turning to FIG. 3, the camera, 101, is not aligned with the subject orientation, 121c. The orientation sensor detects the orientation of the camera, 101, with respect to the subject, 121c, and manipulates the image to cause the image, 103c, to be recorded upright. The image may be stored, projected, printed, transmitted, or viewed.

In this context, orientation sensing may include vertical and horizontal sensing, utilizing different configurations for sensing orientation that are well known. The embodiment of FIG. 4, illustrates a pendulum-type of device, but the invention extends to electronic and mechanical devices that perform the similar orientation function.

It may be noted that while the invention is described herein in its preferred embodiment as operating with two dimensional sensing and orientation, it may also be utilized with three dimensional sensing and orientation. Such three dimensional sensing will allow the invention to correct for a wider range of image distortion such as for example keystone, barrel, perspective and other distortions which occur when the image sensor or image display is located off of the perpendicular axis with respect to the plane of the image being sensed or displayed.

FIG. 4 shows one embodiment of the invention. Shown in partial cutaway, the camera, 101, includes an orientation sensor 131. The angular sensor 131, serves to sense the angular orientation of the camera, 101. The sensor, 131, is linked to the image sensor. This link may be a mechanical link, an electrical link, or a virtual link through a digital representation of the image and a digital representation of the orientation of the camera and sensor.

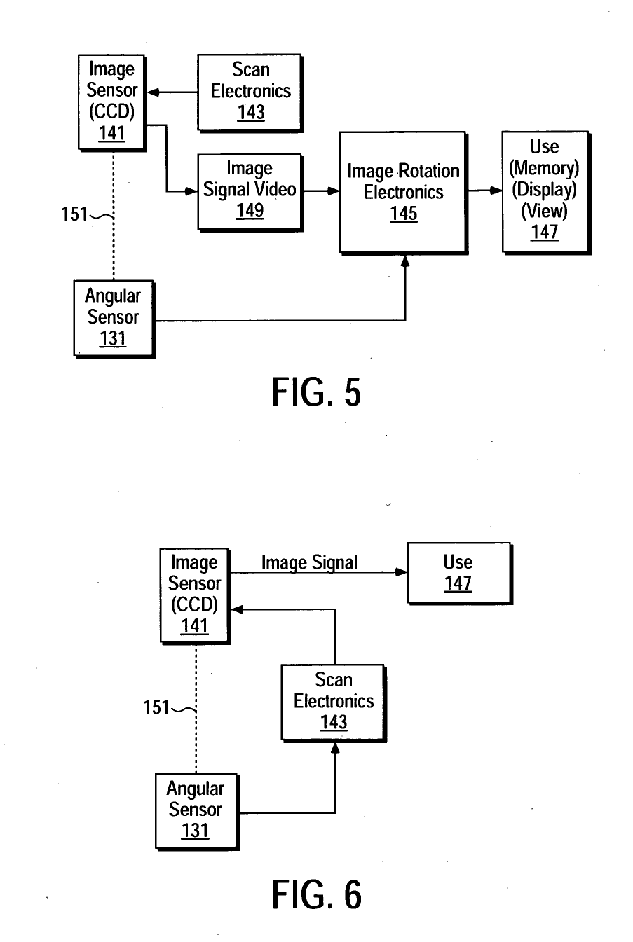

Turning to FIGS. 5, 6, and 7, different embodiments of electronic devices embodying the invention are illustrated. First referring to FIG. 5 as the sensor, 141 is oriented or rotated, 131, orientation sensor outputs a signal, 151, indicative of the rotation. In the embodiment, illustrated in FIG. 4, angular rotation or orientation is determined by rotation of a mass, 133, about a pivot point, 135. Alternatively, the orientation sensor (also referred to as an orientation sensor), 131, may be a gyroscope or virtual gyroscope, such as a microelectromechanical device, an electronic gyroscopic sensor, a mechanical gyroscopic sensor, or an optical gyroscopic sensor, a rotating mass with photo-optical sensor arrayed with a photo emitter and a photo transmitter. Moreover, the orientation sensor can also be a virtual orientation sensor, such as would be used in a virtual “enlarging easel” or “virtual negative carrier” to align a “horizon” with the output picture borders or edges.

The sensor (orientation sensor) outputs a code or signal, 151, as an electrical signal, a digital signal, or movement through a mechanical linkage, indicating the rotation of the image sensor, 141, with respect to, for example, the horizon or true horizontal. The orientation sensor, 131, may measure and indicate three dimensional orientation, as in x, y, and z planes or ρ, θ, and φ axis. These parameters are referred to as “sweeps” and the sweeps may be constrained or unconstrained.

The time constants, including response times and relaxation times of digital, electronic, electrical, and mechanical elements of the total digital imaging system may either dampen movement of the imaging system or filter out movement of the imaging system. For example digital or analog electronic elements may process the orientation sensor signal to provide an image signal.

FIG. 5 shows one embodiment of the invention with correction of the image applied to the image in response to an output signal, 151, from the orientation sensor, 131. The image sensor, 141, such as a charge coupled device (“CCD”), is scanned by scan electronics, 143, to produce an orientation corrected image signal. FIG. 5 further illustrates an image orientation electronics section, 145. This image orientation electronics section, 145, is coupled to receive an orientation signal from the orientation sensor, 131, and rotate or otherwise manipulate the image from the image orientation electronics, 145 to provide an upright image for subsequent use, 147.

The image orientation electronics, 145, may be any image processing circuit, including image resizing and rotation engines, including integrated circuits, firmware, and mixed integrated circuits and firmware, as well as programmed logic devices and application specific integrated circuits. One such integrated circuit image rotation and resizing engine is the Fairchild TMC2302A or the Silicon Optix sxW1-LX integrated circuits which provides high speed image rotation and image manipulation. Further information on these ICs may be found on the web at http://www.fairchildsemi.com/ or http://www.siliconoptix.com, respectively.

FIG. 6 illustrates an embodiment of the invention where the charge coupled device, or other image sensor, 141, and the scan electronics, 143, are coupled to the orientation sensor, 131, to cause the image to be read out of the sensor with the correct orientation for storage or viewing, 147. In one exemplification, the image sensor charge coupled device is bi-directionally readable to the image transfer memory.

It is to be noted, that subject to present image sensor scan electronics and configurations, readouts are limited to the four primary raster scan directions of the image sensor matrix. Alternatively, if the image sensor is a non-pixellated device such as a vacuum tube, as a vidicon or plumbicon tube, the readout can be at any angle through alteration of the deflection axis of the scan beam.

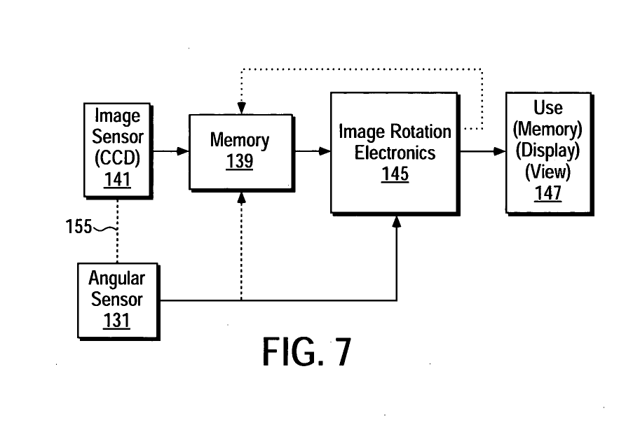

FIG. 7 shows a further exemplification of the invention where the raw image is read out of the sensor, 141, and into a memory, 139, as an image transfer memory or buffer. The correction of image orientation is performed with the image read out of this memory, 139, and the corrected image may be viewed, displayed, transferred, or stored, 147, all in correct orientation. The corrected image may be stored in memory either alone, or with the original captured image, as a set of vectors indicative of the rotation or translation applied.

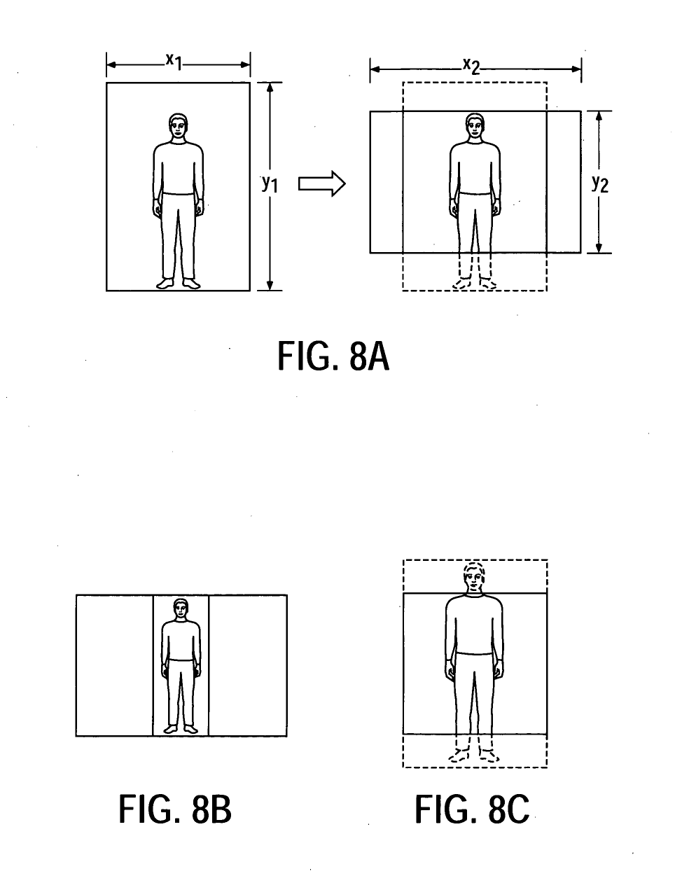

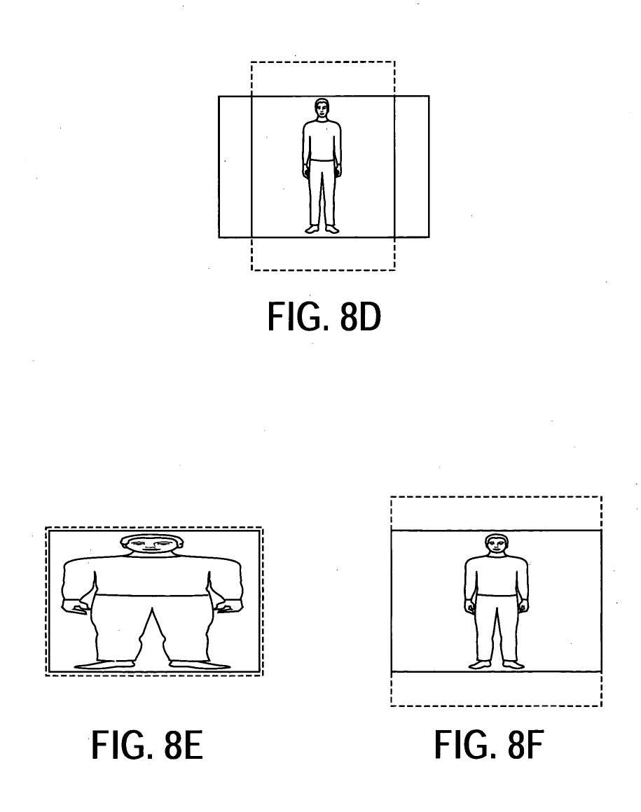

FIG. 8 illustrates a diagram of a problem arising from image rotation when the aspect ratio of the image is other than 1:1. In particular, an original image illustrated in FIG. 8a-1 and having an aspect ratio of X1 units wide by Y1 units high, which is to be displayed on a display having an aspect ratio of X2 units wide by Y2 units high (FIG. 8a-2) will not completely fit. (FIG. 8a-2). Of course the problem will also exist in the reverse where the image of X2, Y2 is displayed with a display of X1, Y1 dimensions (FIG. 8a-1).

Possible solutions to this aspect ratio problem are shown in FIGS. 8b through 8f. In FIG. 8b the largest dimension of the original image is shrunk, e.g., cropped, to fit the smallest dimension of the display, thus leaving unused display areas. In FIG. 8c the largest dimension of the image is cropped, giving the impression or effect that the smallest dimension of the image is stretched to fit the largest dimension of the display, thus cropping portions of the image. In FIG. 8d the smallest dimension of the image is partially cropped to partially fit the largest dimension of the display, thus cropping portions of the image and leaving unused display areas. In FIG. 8e the largest dimension of the original image is shrunk to fit the smallest dimension of the display, and the image is then stretched along its smallest dimension to fill the display areas which would otherwise be unused, and causing a distorted image. In FIG. 8f the largest dimension of the original image is partially shrunk to more closely fit the smallest dimension of the display, and the image is then stretched along its smallest dimension to fill the display areas which would otherwise be unused, and causing a distorted image, but which is less distorted than in FIG. 8e.

These image processing techniques are generally known in the television projector industry where it is often required to display 4:3 aspect ratio images on a 16:9 aspect ratio display, or vice versa, and also for correcting keystoning or other spatial distortions when projectors are located in positions other than perpendicular to the projection screen surface. Such processing may be accomplished with the aforementioned ICs, such as the specifically mentioned Fairchild and Silicon Optix devices.

Of course, one of ordinary skill will recognize the similar relationships and options which will be present in the situation where an image of X2, Y2 dimensions is to be displayed on a display of X1, Y1 dimensions. Further, one of ordinary skill will recognize from these teachings that any of these options may be utilized individually or in combination as desired to practice the invention with a particular image acquisition and display system. The performance of the image resizing, stretching and shrinking may be performed by the Image Rotation Electronics of the previous embodiments, or by separate image resizing electronics as will be known to the person of ordinary skill in the art from these teachings. Again the aforementioned devices such as the Fairchild and Silicon Optix ICs will be useful for such operations.

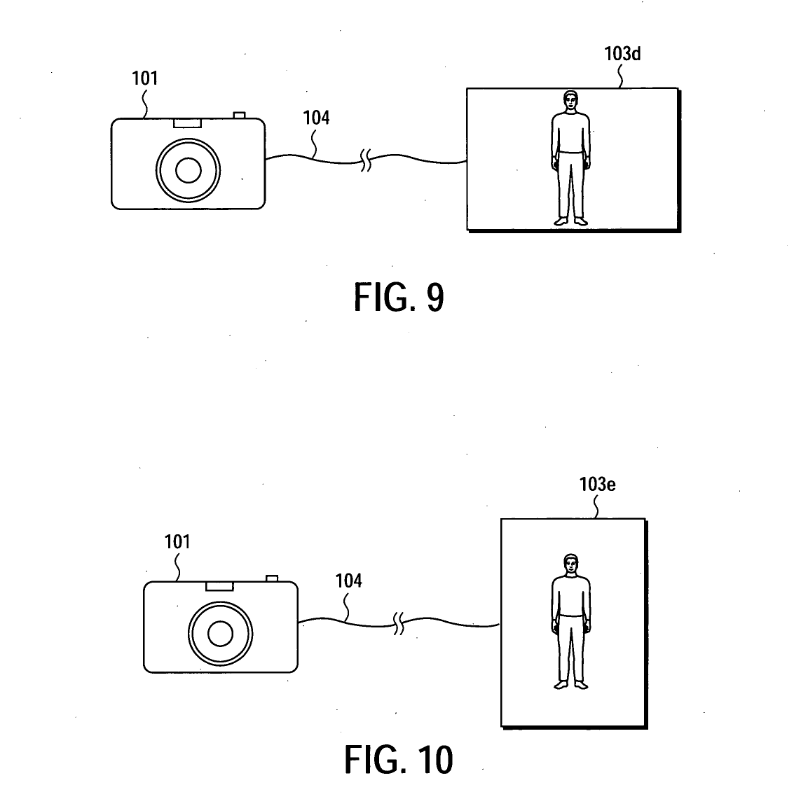

It will be recognized that the invention herein described will also find use with displays which are reoriented, changed in orientation with respect to the camera. For example as seen in FIGS. 9 and 10 it is well known to connect an image sensor such as a camera, 101, to a display, 103d, via electronic connection which may be a cable, optical link, memory device or any of numerous other couplings known in the art. Normally the camera, 101, and display, 103d and 103e are both positioned in an upright configuration; however the camera, 101, may at times be reoriented as described hereinabove, giving rise to the need for the present invention to reorient the image acquired by the camera. It will be recognized that in various applications the image sensor may remain upright and provide an upright acquired image, but the display, 103d and 103e, is reoriented thus giving rise to the need of the invention in respect to the display as shown in FIG. 10. Such applications may for example include mobile displays which are easily moved. One such mobile display with which the invention finds application is cellular phones with video displays. For example, such phones may utilize the invention as part of the acquiring of the image, including storing and transmitting the image, or may utilize the invention as part of the displaying of an image acquired from another cell phone.

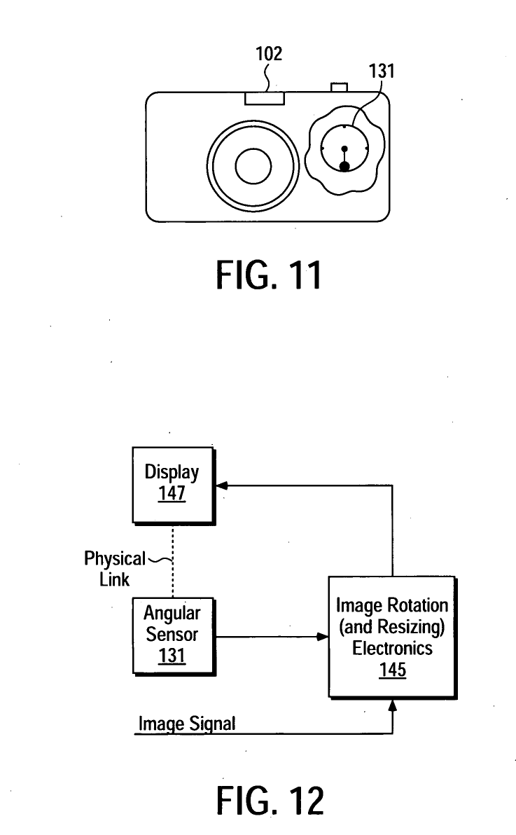

FIG. 11 shows an embodiment of a display, 102, configured according to the invention to display the positional (angular or orientation) sensor to a user. The display, 102, is shown in cutaway exposing the position sensor, 131, which is physically linked to the display so as to provide a position signal indicating the angular position of the display, 102, with respect to upright, as described previously with respect to the image sensor of FIGS. 4-7. It will be recognized that the descriptions given above with respect to the image sensing element will be applicable with respect to the image display element. For example the circuitry of FIGS. 5, 6 and 7 may be equally utilized with display elements and corresponding scan electronics coupled to the position sensor of the display shown by example in FIG. 11.

FIG. 12 shows another embodiment of the invention as used with a display, 147, and including the angular sensor and the image rotation electronics, 147. The display, 102, is physically linked to the position sensor, 131, which is preferred to be an angular sensor as described above, with the sensor outputting a signal indicating the position of the display with respect to the viewer's perceived up orientation. The viewer's perceived up orientation will normally correspond to up as determined in relation to gravity. However in other instances the viewer's orientation or viewpoint may be otherwise oriented, for example for a human viewer lying in bed the perceived up position will be with respect to the viewer's field of vision. The image signal is coupled to a suitable image rotation (and if needed resizing and perspective control) electronics circuit along with the output of the angular sensor with this circuit operating to correctly orient the image for display on the display device.

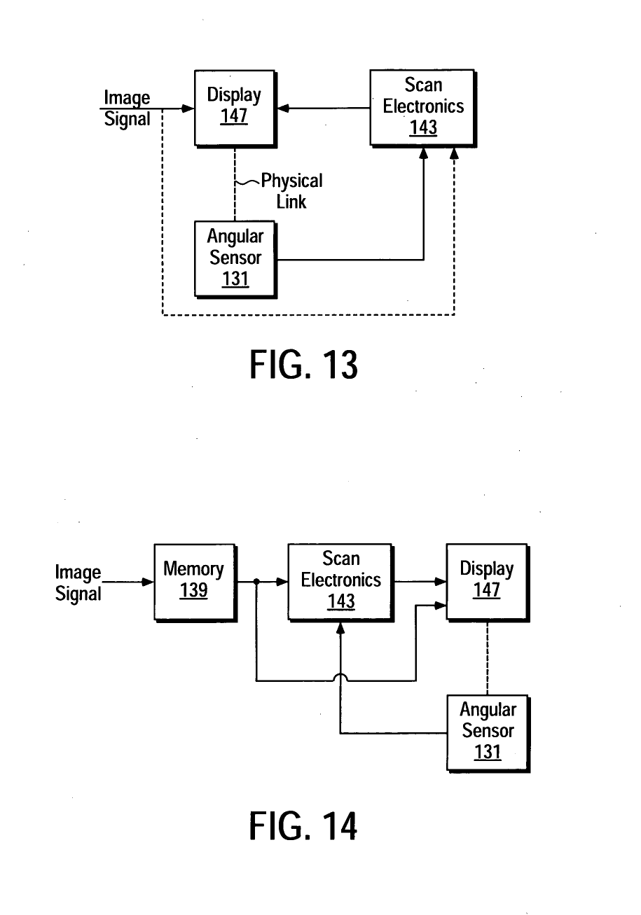

FIG. 13 shows another embodiment of the invention with a display device, 147, scan electronics, 143, and an angular sensor, 131, where the angular sensor, 131, is coupled to the scan electronics, 143, for the display, 147, so that the scanning of the display can reorient and, optionally, resize the image, correct distortions and control perspective as it is being displayed. It is noted that in some displays the scan electronics, 143, are also coupled to the incoming image signal to receive scanning synchronization information contained in the image signal. It will be understood that for such systems the scan electronics, 143, may operate on the image carrying portion of the image signal, or the scanning synchronization information contained in the image signal, or both as desired.

FIG. 14 shows another embodiment of the invention utilized with a display device, 147, wherein the angular sensor, 131, is coupled to the scan electronics, 143, to operate on an image signal which has been captured and stored in memory, 139. As with the FIG. 13 embodiment the scan electronics, 143, may operate on the sync information or the image information or both.

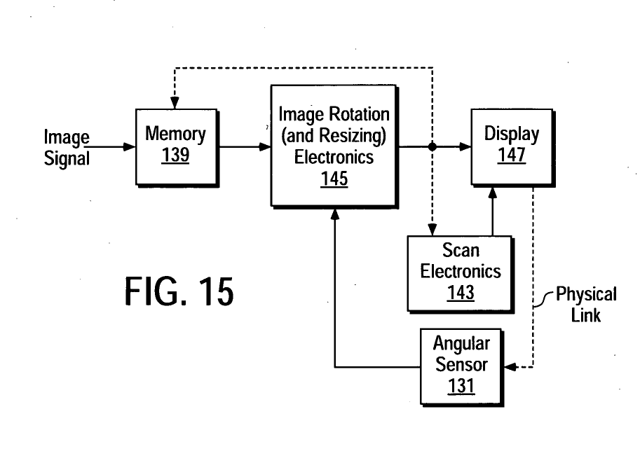

FIG. 15 shows yet another embodiment of the invention wherein the image signal is stored in a memory, 139. As with the embodiment of FIG. 7 an image rotation and if needed resizing electronics circuit, 145, operates in response to the image signal output from the memory, 139, and the signal from the angular sensor, 131, to correctly orient the image for display, 147. The correctly oriented image may be restored in the memory, 139, in place of or in addition to the original stored in memory, 139.

While the invention has been generally described with respect to “in the camera” practice what have come to be the post image capture editing steps performed with image editing software (such as Adobe Photoshop), including “distortion” and “perspective control,” and with respect to image controls used in high end film cameras, such as “perspective control” lenses and the tilts and swings of view camera bellows, it is also to be understood that other advanced image modification techniques can be performed within the image capture electronics. These include those techniques variously referred to as charcoal, charcoal pencil, colored pencil, pastel, sponging, and the like.

It may be noted that combinations of the above embodiments may be resorted to, to fit particular applications of the invention. For example combinations of operations with memory, image rotation, image resizing, and scan electronics may be practiced from the teachings herein, and any of the signals may be stored, manipulated or operated on in any sequence or in parallel. As another example combined image sensor and display devices may be configured, which devices may sense, display, store, send or receive images in any combination while providing reorientation of images as necessary to ensure appropriately reoriented images are presented to the viewer or sent to other viewers as desired. In particular the inventor envisions the use of the invention in video cell phones where the phone contains an angular sensor, image sensor, display, memory and associated support circuitry, wherein images which are sent from the phone are orientation corrected in response to the tilt of the phone when the image is acquired, and images received by the phone for display are oriented in response to the tilt of the phone when displayed.

While the invention has been described with respect to certain preferred embodiments and exemplifications, it is not intended to limit the scope of the invention thereby, but solely by the claims appended hereto and all equivalents.

1. A digital imaging system comprising:
a. an image sensor;
b. an orientation sensor; and
c. an image manipulator adapted to:
i) receive image sensor orientation;
ii) receive image orientation; and
iii) adjust the image orientation.

2. A digital imaging system comprising:
a. an image sensor configured to sense an image subject and to capture a presentation of the image;
b. an orientation sensor configured to sense changes in the orientation of an image with respect to the base line orientation coordinates; and
c. an image manipulator adapted to:
i) receive image sensor orientation from the image sensor;
ii) receive image orientation from the orientation sensor; and
iii) adjust the image orientation in relation to the baseline orientation coordinates.

3. The digital imaging system of claim 1 wherein the digital imaging system is chosen from the group consisting of still cameras and video cameras.

4. The digital imaging system of claim 1 wherein the image sensor is a charge coupled device array.

5. The digital imaging system of claim 1 wherein the orientation sensor is chosen from the group consisting of electronic gyroscopic sensors, mechanical gyroscopic sensors, and optical gyroscopic sensors.

6. The digital imaging sensor of claim 1 wherein the image manipulator comprises an image rotation system.

7. A digital camera comprising:
a. a charge coupled device image sensor;
b. a gyroscopic camera orientation sensor; and
c. an image manipulator adapted to:
i) receive image sensor orientation;
ii) receive image orientation; and
iii) rotate the image.

8. The digital camera of claim 6 wherein the digital camera is chosen from the group consisting of still cameras and video cameras.

9. The digital camera of claim 6 wherein the gyroscopic orientation sensor is chosen from the group consisting of electronic gyroscopic sensors, mechanical gyroscopic sensors, and optical gyroscopic sensors.
